(19) United States
(12) Patent Application Publication
(10) Pub. No.: US 2014/0244890 A1
(43) Pub. Date: Aug. 28, 2014

(54) CABLE, USER APPARATUS CONNECTED WITH CABLE, AND OPERATING METHOD THEREOF

(71) Applicant: Samsung Electronics Co., Ltd., Gyeonggi-do (KR)

(72) Inventors: Gyoung-Hwan PARK, Gyeongsangbuk-do (KR); Hyo-Jin KIM, Gyeonggi-do (KR); Won-Seob KIM, Seoul (KR); Dong-Ho YU, Gyeonggi-do (KR); Eun-Seok HONG, Gyeonggi-do (KR); Sang-Hyun RYU, Gyeonggi-do (KR); Woo-Sung JANG, Gyeonggi-do (KR)

(73) Assignee: Samsung Electronics Co., Ltd., Gyeonggi-do (KR)

(21) Appl. No.: 14/190,291

(22) Filed: Feb. 26, 2014

(30) Foreign Application Priority Data
Feb. 26, 2013 (KR) 10-2013-0020408

(51) Int. Cl. G06F 13/40

(52) U.S. Cl. CPC G06F 13/4022
USPC 710/317

(57) ABSTRACT

A method, electronic device apparatus and a cable apparatus for reducing crosstalk in a signal transmitted to an electronic device through the cable apparatus are disclosed. The cable apparatus has a plurality of signal lines. The device and method may determine a relevant communication scheme, activate the relevant communication scheme by electrically coupling at least one of the plurality of signal lines of the cable apparatus correlating to the activated relevant communication scheme. At least one of the plurality of signal lines of the cable apparatus not correlating to the activated relevant communication scheme is electrically grounded.

### CLAIM OF PRIORITY

This application claims the benefit under 35 U.S.C. §119(a) to a Korean patent application filed in the Korean Intellectual Property Office on Feb. 26, 2013 and assigned Serial No. 10-2013-0020408, the entire disclosure of which is hereby incorporated by reference.

### TECHNICAL FIELD

The present disclosure relates to a cable for improving the quality of an electric signal, a user apparatus connected with the cable, and an operating method thereof.

### BACKGROUND

Generally, a variety of communication cables and port interfaces are used for communicatively coupling a computer and a peripheral. Accordingly, a person of average computer knowledge may encounter difficulty in connecting a peripheral to a computer. That is, it is often confusing to determine which port and cable should be used to connect a peripheral to a computer. Additionally, the computer or peripheral may require the user to dictate the appropriate settings that will facilitate normal operation of the peripheral or computer after connection of the peripheral to the computer.

This also presents difficulty for manufacturers of computer, peripheral and cable products. If devices utilize an unstandardized plurality of communication schemes, standards and interfaces, it becomes difficult if not impossible for manufacturers to (for example) select an adequate range of solutions for installation on a personal computers and peripherals that will adequately cover the needs of any particular user base. When computer peripheral interfaces are standardized, and they are automatically usable state upon connection without the need for user input or configuration, the difficulties presented above are significantly mitigated. Additionally, if the connected peripherals can operate without need for a separate external power source connection, user convenience is significantly enhanced.

To solve this problem, the Universal Serial Bus (“USB”) industry standard was developed, defining a number of standards for cables, connectors, communication protocols and power supplies to electronic devices. USB has become a relatively ubiquitous, as it is highly convenient for users. For example, USB supports so-called “plug-and-play” functionality, wherein a computer automatically detects connection of a peripheral when the relevant communication cable is coupled to the peripheral and to the computer (although some USB communication devices still require manual installation of software for full functionality). Similarly, in the past, connecting a peripheral required one to shut down a computer before connecting the peripheral. In contrast, the USB standard supports “hot-swapping,” which allows devices to be connected, disconnected or even exchanged with both the computer and peripheral powered on. Finally, cables and ports adhering to the USB standard are able to supply power to a peripheral, in tandem with communicatively coupling peripherals and computers. As a result, most small USB-enabled devices operate without a dedicated power connection, including (for example) peripherals such as the computer mouse, the keyboard, and external hard disk storage devices. Even some large devices, such as a printers and scanners, now operate without a separate power supply. Manufacturers have taken note, as USB compliant cables are also used for charging mobile devices (such as a mobile phone or an MP3 player), taking full advantage of this characteristic of the USB communication. These various advantages explain the near universal adoption of the USB standard for a plurality of computer peripherals.

The recent USB 3.0 revision of the USB standard communication has been commercialized (itself an improvement over the previous USB 2.0 revision). The USB 3.0 revision provides faster transmission speed than the conventional USB 2.0 revision, and the power supply capacity has been increased from 500 mA to 900 mA.

Recently, with the growth of the electronic communications industry, mobile communication apparatuses such as mobile communication terminals (i.e., cellular phones), electronic schedulers, Personal Digital Assistants (PDAs), etc. have become integral to life in modern society. These mobile devices provide various data transmission services (i.e., Internet, e-mail, etc.), voice communication services (i.e., traditional phone calls and “voice-over-IP”), along with various additional services (i.e., multimedia, entertainment, data storage, etc.), and have thus evolved into a prolific and versatile multimedia-capable communication devices. Despite the obvious advantages of the USB 3.0 revision standard (as described above), mobile devices have yet to fully adopt the USB 3.0 standard. In an era when information is increasingly shared and synchronized between devices such as mobile phones, laptop and desktop computers, users will benefit greatly from ever faster means of transferring information between devices. It is therefore urgent and beneficial that USB 3.0 is adopted for mobile devices.

Notably, cables that adhere to the USB 3.0 revision are presently mass-produced. These cables generally include a USB 2.0 communication signal line as well as a USB 3.0 communication signal line to ensure backwards compatibility with peripherals that require the USB 2.0 revision standard. However, the addition of the USB 3.0 communication signal line (both in the cable, and at the point of connection) causes the performance of the cable to deteriorate due to the effects of channel noise and interference from neighboring signals.

### SUMMARY

One aspect of the present invention is to provide a USB 3.0 communication cable capable of improved cable performance relative to other USB 3.0 communication cables.

Another aspect of the present invention is to provide a USB 3.0 cable that disposes a USB 2.0 communication signal line (included to ensure backwards compatibility) between a power transmission line and a USB 3.0 communication signal line.

Another aspect of the present invention is to provide a USB 3.0 communication cable that disposes a USB 3.0 communication signal line so that it is spaced apart and away from a power transmission line.

Another aspect of the present invention is to provide an electronic device that applies the USB 3.0 revision standard, such as a cellular phone, a PDA, etc.

Another aspect of the present invention is to provide an electronic device that grounds at least one signal line not corresponding to an activated communication scheme, and an operating method thereof.

Another aspect of the present invention is to provide an electronic device that grounds at least one signal line corresponding to a USB 2.0 communication signal line when USB 3.0 communication is activated, and an operating method thereof.

Another aspect of the present invention is to provide an electronic device that may reduce deterioration of signal integrity and block noise when connecting a USB communication cable with an electronic device, where the connection is achieved by fitting a plug connector (prepared in an end of the USB communication cable) into a receiving socket connector of the electronic device, and an operating method thereof.

Another aspect of the present invention is to provide an electronic device that utilizes a USB 2.0 communication signal line (included to ensure backwards compatibility) in a USB 3.0 communication cable as an additional grounding body when connecting the USB 3.0 communication cable with an electronic device, where the connection is achieved by fitting a plug connector (prepared in an end of the USB communication cable) into a socket connector of the electronic device, and an operating method thereof.

Another aspect of the present invention is to provide an electronic device that grounds at least one terminal of a socket connector of a USB 3.0 communication cable when USB 3.0 communication is activated, the USB 3.0 communication cable including a USB 2.0 communication signal line to ensure backwards compatibility, the socket connector corresponding to the USB 2.0 communication signal line, and an operating method thereof.

In accordance with another aspect of the present invention, a method for controlling a signal line is provided. The method may include activating a relevant communication scheme, and grounding at least one signal line that does not correspond to the activated communication scheme.

In accordance with another aspect of the present invention, the method may further include activating at least one signal line corresponding to the activated communication line.

In accordance with another aspect of the present invention, the activated communication scheme may be a communication scheme compatible with a counterpart communication apparatus.

In accordance with another aspect of the present invention, the at least one signal line that does not correspond to the activated communication scheme may be connected with a terminal for connecting a counterpart peripheral.

In accordance with another aspect of the present invention, the at least one signal line that does not correspond to the activated communication scheme may correspond to a more recent revision or an older revision of the communication scheme relative to the activated communication scheme.

In accordance with another aspect of the present invention, the activated communication scheme may be a USB 3.0 communication scheme or a USB 2.0 communication scheme.

In accordance with another aspect of the present invention, an electronic device is provided. The electronic device may include at least one processor, a memory unit, a switch device electrically coupled with the processor, and at least one program stored in the memory unit and configured for execution by the at least one processor, wherein the program may cause the processor to control the switch device to ground at least one signal line not corresponding to an activated communication scheme.

In accordance with another aspect of the present invention, the program may control the switch device to electrically couple at least one signal line corresponding to the activated communication scheme with the processor.

In accordance with another aspect of the present invention, the activated communication scheme may be a communication scheme compatible with a counterpart communication apparatus.

In accordance with another aspect of the present invention, the at least one signal line not corresponding to the activated communication scheme may be connected to a terminal for connecting a counterpart peripheral.

In accordance with another aspect of the present invention, the at least one signal line not corresponding to the activated communication scheme may correspond to a recent revision of an older revision of a communication scheme relative to the activated communication scheme.

In accordance with another aspect of the present invention, the activated communication scheme may be a USB 3.0 communication scheme or a USB 2.0 communication scheme.

In accordance with another aspect of the present invention, an electronic device is provided. The electronic device may include a mainboard, a socket connector mounted on the mainboard for connecting a peripheral, a switch device mounted on the mainboard for controlling a plurality of signal lines electrically connected with the socket connector, wherein the switch device may ground at least one signal line from among the plurality of signal lines not corresponding to an activated communication scheme.

In accordance with another aspect of the present invention, the switch device may electrically connect at least one signal line corresponding to the activated communication scheme from among the plurality of signal lines.

In accordance with another aspect of the present invention, the activated communication scheme may be a communication scheme compatible with a counterpart communication apparatus.

In accordance with another aspect of the present invention, the at least one signal line not corresponding to the activated communication scheme may correspond to a recent revision or an older revision of the communication scheme to relative to the activated communication scheme.

In accordance with another aspect of the present invention, the activated communication scheme may be a USB 3.0 communication scheme or a USB 2.0 communication scheme.

In accordance with another aspect of the present invention, a cable is provided. The cable may include a sheath and a plurality of lines disposed inside the sheath, wherein at least one line corresponding to a first communication scheme may be disposed on an outer side relative to at least one line corresponding to a second communication scheme.

In accordance with another aspect of the present invention, the at least one line corresponding to the first communication scheme may be disposed centrally within the cable.

In accordance with another aspect of the present invention, the at least one line corresponding to the first communication scheme may be disposed between at least one line corresponding to the second communication scheme and a power transmission line.

In accordance with another aspect of the present invention, the first communication scheme may be a recent revision or an older revision of the communication scheme relative to the second communication scheme.

In accordance with another aspect of the present invention, the first communication scheme may be a USB 3.0 communication scheme or a USB 2.0 communication scheme.

Other aspects, advantages and salient features of the invention will become apparent to those skilled in the art from the following detailed description, which, when taken in conjunction with the annexed drawings, discloses example embodiments of the invention.

### BRIEF DESCRIPTION OF THE DRAWINGS

Example embodiments of the present invention will be more apparent from the following description taken in conjunction with the accompanying drawings in which:

FIG. 1 is a perspective view illustrating a user apparatus according to one embodiment of the present invention;

FIG. 2 is a perspective view illustrating a mainboard of a user apparatus according to one embodiment of the present invention;

FIG. 3 is a perspective view illustrating a plug connector and a cable according to an embodiment of the present invention;

FIG. 4 is a cross-sectional view illustrating a USB 3.0 cable according to one embodiment of the present invention;

FIG. 5 is a functional block diagram illustrating a user apparatus according to one embodiment of the present invention;

FIG. 6 is a flowchart illustrating a method of using a USB signal line as an electrical ground according to one embodiment of the present invention;

FIG. 7 is a flowchart illustrating a method of determining which USB signal line should be activated according to one embodiment of the present invention;

FIG. 8 is a block diagram illustrating various communication configurations between a host unit and a socket connector according to one embodiment of the present invention;

FIG. 9 is a block diagram illustrating various communication configurations between a host unit and a socket connector according to one embodiment of the present invention;

FIG. 10 is a block diagram illustrating various communication configurations between a host unit and a socket connector according to one embodiment of the present invention; and

FIG. 11 is a block diagram illustrating various communication configurations between a host unit and a socket connector according to one embodiment of the present invention.

Throughout the drawings, like reference numerals will be understood to refer to like parts, components and structures.

### DETAILED DESCRIPTION

The following description, with reference to the accompanying drawings, is provided to assist in a comprehensive understanding of example embodiments of the invention, as defined by the claims and their equivalents. It includes various specific details to assist in that understanding, but these are to be regarded as merely illustrative. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of example embodiments of the present invention are provided for illustration purposes only, and should not be construed as limiting the invention to the embodiment described herein. Rather, the invention should be construed to encompass the full range of material as defined by the claims, and their equivalents.

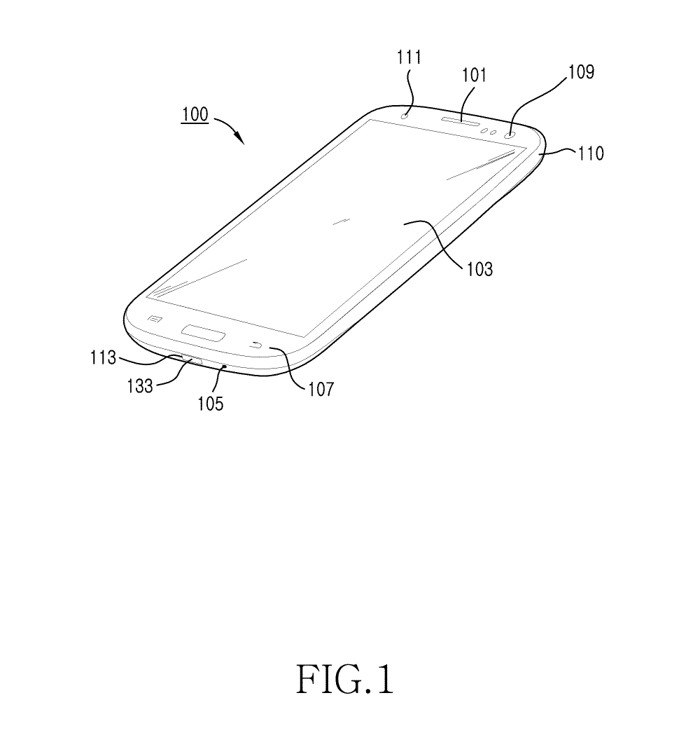

FIG. 1 is a perspective view illustrating a user apparatus 100 according to one embodiment of the present invention. The user apparatus 100 may be any computerized peripheral, computing device or mobile apparatus. For illustrative purposes, FIG. 1 depicts a user apparatus 100 smartphone. The user apparatus 100 may therefore include a speaker 101 for outputting sound, a touchscreen 103 positioned below the speaker 101 to display an image and receive touch-based user inputs, a microphone 105 positioned below the touchscreen 103 to receive a sound, a plurality of buttons 107 for generating input signals corresponding to pressure or touch-based user inputs in the corresponding locations, a camera 109 for recording video, and at least one sensor 111 for detecting a physical quantity such as heat, light, temperature, pressure, a sound, etc., or a change thereof.

The user apparatus 100 (when in the form of a smartphone) preferably utilizes a housing 110, and the above-described elements may be fixed within, affixed to, built into, set in or otherwise received in the housing 110. The housing 110 may include a front housing corresponding to a front portion of the user apparatus 100 (depicted in FIG. 1), a rear housing corresponding to a rear portion of the user apparatus 100, and a battery cover removably coupled the rear housing. A battery may be disposed in the space defined by a gap between the rear housing and the battery cover, when the rear housing and battery cover are coupled.

The touchscreen 103 may also help define a window, a touch panel disposed below the window, and a display disposed below the touch panel. The touchscreen 103 may be disposed on a Printed Circuit Board (“PCB”) and electrically coupled with the PCB. The PCB is a substrate on which circuitry and a plurality of electronic parts are mounted. The PCB may define a computing environment for the user apparatus 100, maintains information thereof, and allows the user apparatus 100 to be stably driven, allows all devices of the user apparatus 100 to swiftly perform data exchange, and generally facilitates the operation of the entire user apparatus 100. The PCB may also be referred to as a “mainboard.”

The user apparatus 100 preferably includes a socket connector 133, which is exposed via an opening 113 in the housing 110. The socket connector 133 is preferably electrically connected with the mainboard. The socket connector 133 denotes a connection portion used for connecting a peripheral or connecting the user apparatus to another computing device, typically via the use of a communication cable. The socket connector 133 may therefore be configured to receive some plug connector of a communication cable or charging cable through the opening 113.

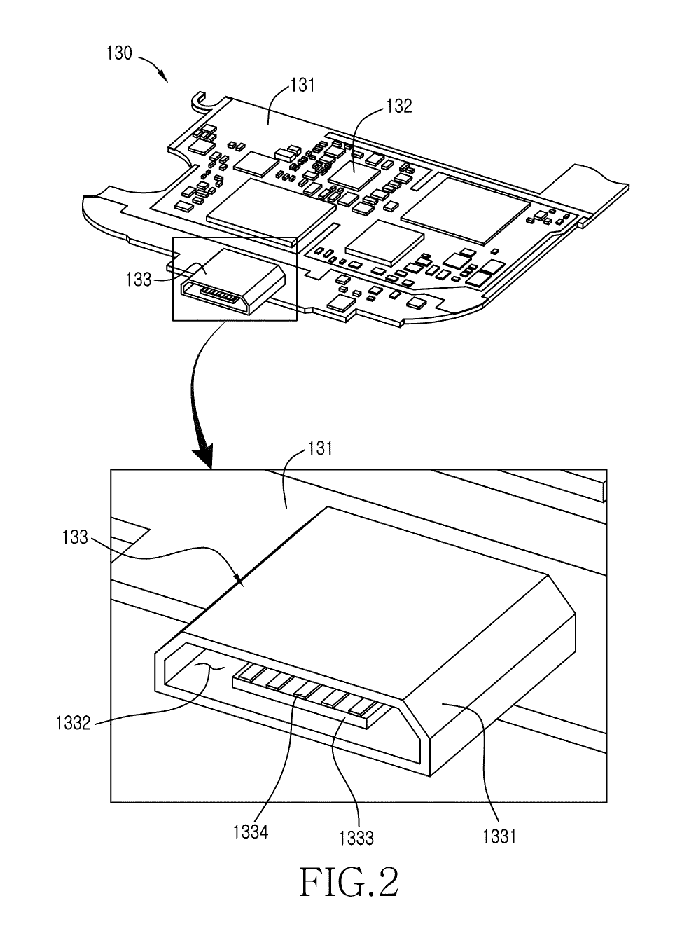

FIG. 2 is a perspective view illustrating a mainboard 130 of a user apparatus 100 according to an embodiment of the present invention. The mainboard 130 may include a substrate 131, a plurality of electronic parts 132, and a circuit mounted on the substrate 131. A socket connector 133 may be mounted on an edge of the substrate 131 of the mainboard 130. In embodiments where the mainboard 130 is seated and/or affixed to the housing 110 of the user apparatus 100, the socket connector 133 is preferably exposed via the opening 113 of the housing 110.

The socket connector 133 preferably includes a terminal mount portion 1333, and a socket housing 1331 enclosing the terminal mount portion 1333. Terminals 1334 are “mounted” on or otherwise affixed to the terminal mount portion 1333, and may protrude towards the opening of the socket housing 1331.

The socket housing 1331 may define a gap or space 1332, which may advantageously guide insertion of a plug connector of a communication cable when it is coupled to the socket connector 133. The plug connector of the communication cable would be inserted into this the 1332, forcing electrical contacts on the plug connector to electrically contact the terminals 1334 affixed to the terminal mount portion 1333.

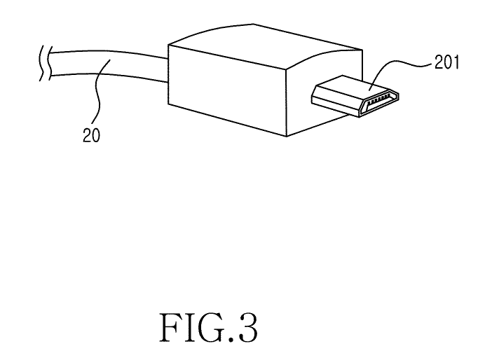

FIG. 3 is a perspective view illustrating a plug connector 201 and a communication cable 20 according to one embodiment of the present invention. The plug connector 201 may be received by the socket connector 133 of the user apparatus 100, electrically coupling the communication cable 20 with the socket connector 133, and thus, with the mainboard 130. The plug connector 201 may be coupled to the one end of the communication cable 20.

In the case where the plug connector 201 is fit into the socket housing 1331 of the socket connector 133, the plug connector 201 has terminals electrically contacting the terminals 1334 of the socket connector 133. The terminals of the plug connector 201 may elastically pressurize the terminals 1334 of the socket connector 133. The terminals of the plug connector 201 may be electrically connected with the lines of the cable 20, respectively.

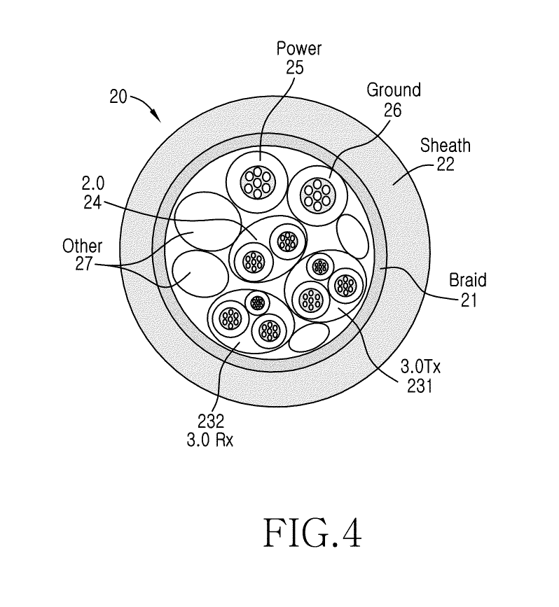

FIG. 4 is a cross-sectional view illustrating a USB 3.0 cable 20, according to one embodiment of the present invention. The USB 3.0 cable 20 may include a sheath and a plurality of lines 22, 231, 121, 24, 25, 26, and 27 enclosed within the sheath. The sheath 20 may contain and protect the plurality of lines, and preferably includes a braid 21 and an outer jacket 22 enclosing the braid 21. The lines may include USB 3.0 communication signal lines 231 and 232, USB 2.0 communication signal lines 24, a power transmission line 25, a ground line 26, and other lines 27.

The USB 3.0 communication signal lines may include USB 3.0 transmitter (“Tx”) signal lines 231 and USB 3.0 receiver (“Rx”) signal lines 232. The USB 3.0 Tx signal lines 231 and the USB 3.0 Rx signal lines 232 are exclusive lines for transmitting and receiving signals respectively and simultaneously, and may be applied to a duplex communication channel.

The USB 2.0 communication signal lines 24 may be included in the USB 3.0 cable 20 to ensure backwards compatibility with peripherals and devices that cannot utilize USB 3.0 communication standards.

When the plug connector 201 of the USB 3.0 communication cable 20 has been coupled to the socket connector 133 of the user apparatus 100, signals and electrical currents sent through the USB 2.0 communication signal lines 24 may interfere with electrical currents and signals of the USB 3.0 communication signal lines 231 and 232. Similarly, signals and electrical currents sent through the USB 3.0 communication signal lines 231 and 232 may interfere with signals and electrical currents of the USB 2.0 communication signal lines 24.

This may be advantageously resolved by electrically grounding the unused signal line relative to the mainboard 130. Therefore, where the USB 3.0 communication signal lines 231 and 232 are being utilized (that is, where USB 3.0 communication is active), the user apparatus 100 may ground at least one signal line electrically connected with the USB 2.0 communication signal lines 24. Therefore, the USB 2.0 communication signal lines 24 of the USB 3.0 communication cable 20 may be electrically connected with the ground of the mainboard 130 of the user apparatus 100, operating as an additional grounding body. As a result, any degradation caused by interference and noise from the USB 2.0 communication signal lines 24 may be reduced. For example, when USB 3.0 communication signal lines 231 and 232 are active, the grounded USB 2.0 communication signal lines 24 may reduce, prevent or eliminate crosstalk in the USB 3.0 communication signal lines 231 and 232.

The grounded USB 2.0 communication signal line 24 may be beneficial in other contexts as well. For example, a user may desire to charge the battery of the user apparatus 100 with the USB 3.0 communication active. The user apparatus 100 may activate the power transmission line 25 of the USB 3.0 communication cable 20. The user apparatus 100 may therefore receive a Direct Current (DC) voltage from a peripheral via the power transmission line 25, charging the battery. The grounded USB 2.0 communication signal lines 24 prevent unwanted signals, such as electrical noise generated from the charging of the user apparatus 100, and noise generated from the power transmission line 25 being introduced to the user apparatus 100. The grounded USB 2.0 communication signal line 24 continues to facilitate clear communication for the USB 3.0 communication signal lines 231 and 232.

Similarly, where the USB 2.0 communication signal lines 24 are being utilized (that is, USB 2.0 communication is active), the user apparatus 100 may ground at least one (or both) of the USB 3.0 communication signal lines 231 and 232, whereby one or both of the lines 231 and 232 would serve as an additional grounding body. As a result, any degradation caused by interference and noise from the USB 3.0 communication signal lines 231 and 232 may be reduce, prevent or eliminate crosstalk in the USB 3.0 communication signal lines 231 and 232.

Similar to the above, the grounded USB 3.0 signal line 24 may be beneficial in other contexts as well. For example, a user may desire to charge the battery of the user apparatus 100 with USB 2.0 communication active. The user apparatus 100 may to activate the power transmission line 25 of the USB 3.0 communication cable 20. A charging portion of the user apparatus 100 may receive a Direct Current (DC) voltage from a peripheral via the power transmission line 25, charging the battery. The grounded USB 3.0 communication signal lines 231 and/or 232 prevent unwanted signals, such as electrical noise generated from the charging of the user apparatus 100, and noise generated from the power transmission line 25 being introduced to the user apparatus 100. The grounded USB 3.0 communication signal lines 231 and/or 232 thereby facilitate clear communication for the USB 2.0 communication signal lines 24.

The determination of which signal line (i.e., the USB 3.0 or USB 2.0 signal lines) to be grounded may be determined automatically. The user apparatus 100 may determine which USB communication standard is required based on information provided from the connected external peripheral via a relevant line of the USB 3.0 communication cable 20. When the peripheral is compatible with the USB 3.0 communication, the user apparatus 100 may activate USB 3.0 communication signal lines 231 and 232, and ground USB 2.0 communication signal lines 24. Tangentially, when the peripheral is compatible with the USB 2.0 communication, the user apparatus 100 may activate the USB 2.0 communication signal line 24, and ground USB 3.0 communication signal lines 231 and 232.

The physical arrangement of the various signal lines may also have beneficial effects with regard to the clarity of electronic signals and the reduction of crosstalk. Therefore, in one embodiment, the USB 2.0 communication signal lines 24 may be disposed between the USB 3.0 communication signal lines 231 and 232, and the power transmission line 25. The resulting arrangement spaces the USB 3.0 communication signal lines 231 and 232 away and apart from the power transmission line 25, reducing interference, noise and crosstalk from the power transmission line 25.

In another embodiment, the USB 2.0 communication signal lines 24 may be disposed between the USB 3.0 communication signal lines 231 and 232. In this arrangement, the USB 2.0 communication signal lines 24 may be surrounded by other lines 231, 232, 25, 26, 27, and generally disposed towards a central location of the USB 3.0 communication cable 20. The resulting arrangement prevents noise, interference and crosstalk from between USB 3.0 communication line 231 and USB 3.0 communication line 232. In yet another embodiment, the USB 3.0 communication signal lines 231 and 232, the power transmission line 25, the ground line 26, and other lines 27 may be disposed towards the outer circumferential edges of the cable 20. In the resulting arrangement, the USB 2.0 communication signal lines 24 may serve as a buffer for preventing crosstalk between the USB 3.0 communication signal lines 231 and 232, and generally reducing noise from other lines (such as the power transmission line 25) for the USB 3.0 communication signal lines 231 and 232.

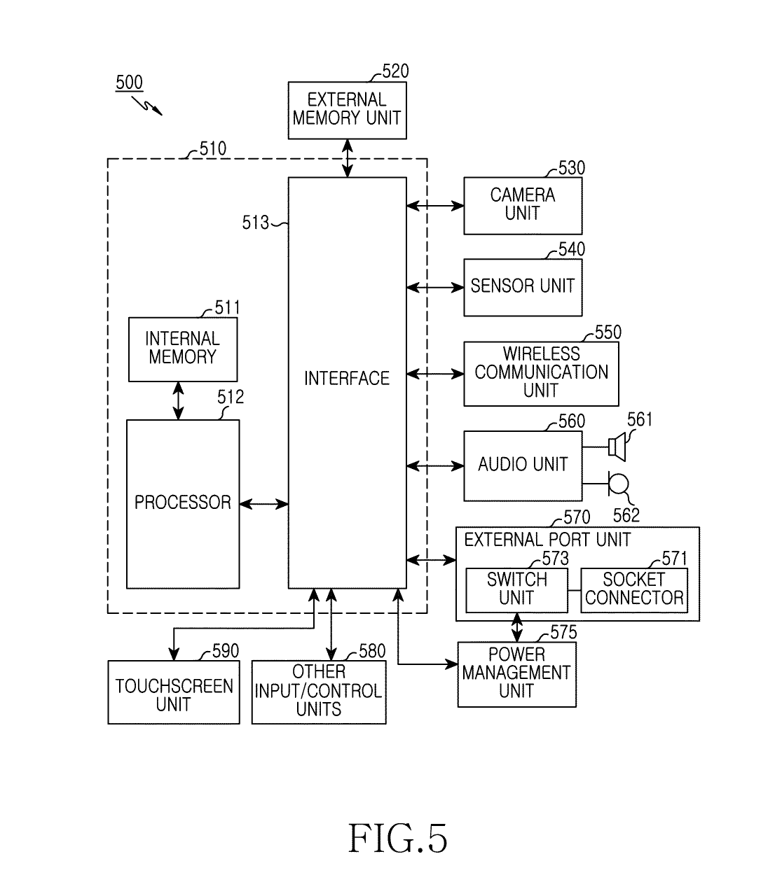

FIG. 5 is a functional block diagram illustrating a user apparatus according to one embodiment of the present invention. The user apparatus 500 may be a device such as a mobile phone, a mobile pad, a media player, a tablet computer, a handheld computer, a Personal Digital Assistant (“PDA”), etc. The user apparatus 500 may also be an electronic device that combines or includes functionality provided the listed devices.

The user apparatus 500 includes a host unit 510, an external memory unit 520, a camera unit 530, a sensor unit 540, a wireless communication unit 550, an audio unit 560, an external port unit 570, a power management unit 575, other input/control units 580, and a touchscreen unit 590. A plurality of external memory units 520 and external port units 570 may be provided.

The host unit 510 may include internal memory 511, one or more processors 512, and an interface 513. The internal memory 511, one or more processors 512, and the interface 513 may be separate elements, or they may be configured as and/or combined in one or more integrated circuit units.

The processor 512 may execute various computer programs and instructions to facilitate and provide the various functions of the user apparatus 500, controlling (for example) voice communication, video communication and data communication. In addition to these general functions, the processor 512 may execute software programs (i.e., instruction sets) stored in the internal memory 511 and/or the external memory unit 520 to perform the required functions corresponding to the executed program. In addition to these general functions, the processor 512 may execute a specific program stored in the internal memory 511 and/or the external memory unit 520 to perform various specific functions corresponding to the specific program. In short, the processor 512 may perform a method facilitating an embodiment of the present invention, which may take the form of (for example) software instructions stored in the internal memory 511 and/or the external memory unit 520. The processor 512 may include one or more data processors, image processors, or a CODEC. Furthermore, the data processor, the image processor, and the CODEC may be implemented on the user apparatus 500 within a single unit, or as separate units.

The interface 513 may communicatively couple the various units of the user apparatus 500 with the host unit 510, facilitating data exchange, control and coordination of the various units of the user apparatus 500.

The camera unit 530 may be provided for image recording, video clip recording, etc. The camera unit 530 may include a Charged Coupled Device (CCD) or a Complementary Metal Oxide Semiconductor (CMOS), etc. The camera unit 530 may control alterations of hardware configurations related to the camera unit 530 and photography. For example, the camera unit 530 may control lens movement, an “f-number” or “focal ratio” of a camera aperture, depending on the camera program being executed by the processor 512.

The various elements of the user apparatus 500 may be connected via one or more communication buses (reference numeral not shown) or stream lines (reference numeral not shown).

The sensor unit 540 may include a movement sensor, a light sensor, a temperature sensor, etc., and may enable various functions. For example, the movement sensor may detect movement of the user apparatus 500, and the light sensor may detect ambient light.

The wireless communication unit 550 enables wireless communication, and may include a Radio Frequency (“RF”) transmitter/receiver, and a light transmitter/receiver (such as an infrared transmitter/receiver). The wireless communication unit 550 may be designed to operate via one of a “Global System for Mobile Communications” (“GSM”) network, an “Enhanced Data rates for GSM Evolution” (“EDGE”) network, a “Code Division Multiple Access” (“CDMA”) network, a “Wideband Code Division Multiple access” (“W-CDMA”) network, a “Long Term Evolution” (“LTE”) network, an “Orthogonal Frequency-Division Multiple Access” (“OFDMA”) network, a “IEEE 802.11b Direct Sequence” (“Wi-Fi”) network, a “Worldwide Interoperability for Microwave Access” (“WiMax”) network and/or a Bluetooth network depending on a communication network.

The audio unit 560 may be connected with a speaker 561 and a microphone 562 to enable audio input and output, facilitating functions such as voice recognition-based data input, voice duplication, digital recording, communication functions, etc. That is, the audio unit 560 may facilitate outputs sent to the user via the speaker 561 and inputs received from the user via the microphone 562. To output sound, the audio unit 560 may receive a data signal from the host unit 510, convert the received data signal to an electric signal, and output the converted electric signal via the speaker 561. The speaker 561 may convert an electric signal to an audio frequency band and output the same. To input sound information, the microphone 562 may convert a sound wave emanating from a person or other sound source to an electric signal. The audio unit 560 may receive an electric signal from the microphone 562, convert the received electric signal to an audio data signal, and transmit the converted audio data signal to the host unit 510. The audio unit 560 may include a wired or wireless earphone, headphone, or headset removably coupled to the user apparatus 500.

The external port unit 570 may include a socket connector 571 and a switch unit 573. The socket connector 571 represents a connection portion of the external port unit 570 used for connection with a peripheral, and may correspond to the above-described socket connector 133 (from FIGS. 1 and 2). Upon instruction from the processor 512, the switch unit 573 may alter its configuration so as to communicatively couple the host unit 510 with an input from the socket connector 133, or it may alter its configuration to ground at least one signal line not corresponding to an activated communication scheme. The switch unit 573 is preferably responsible for controlling a plurality of signal lines originating from a cable electrically coupled to the socket connector 571 (i.e., a USB 3.0 cable). These signal lines may be electrically coupled with the electrical terminals of the socket connector 571.

For example, the processor 512 may determine that a peripheral communicatively coupled to the host unit 500 requires the use of a USB 3.0 communication scheme (rather than a USB 2.0 communication scheme) from information provided from the peripheral (via the USB 3.0 communication cable 20). Therefore, the processor 512 may cause the switch unit 573 to couple the host unit 510 with the external port unit 570 via a signal line correlating to the desired USB 3.0 communication, and simultaneously ground at least one signal line correlating to USB 2.0 communication. At least one signal line correlating to USB 2.0 communication may thus be connected with the socket connector 571, but is nevertheless grounded without actually being communicatively connected with the host unit 510.

Similarly, when it is determined that the peripheral requires the use of a USB 2.0 communication scheme, the processor 512 may cause the switch unit 573 to communicatively couple the host unit 510 with the external port unit 570 via a signal line correlating to the USB 2.0 communication scheme, and ground at least one signal line correlating to the USB 3.0 communication scheme. The at least one signal line correlating to the USB 3.0 communication scheme may therefore be connected with the socket connector 571, but is grounded and entirely communicatively disconnected with the host unit 510.

Regardless of which signal line is communicatively coupled to the host unit 510, and which is grounded, at least one signal line in the USB 3.0 communication cable 20 not corresponding to the activated USB communication scheme is preferably electrically connected with the ground of the user apparatus 100, to serve as an additional ground body and prevent crosstalk and electrical noise. The power management unit 575 may control the allocation of power to respective elements of the user apparatus 100, under the auspices of the processor 512. The power management unit 575 may also facilitate charging of the device's battery. The power management unit 575 may facilitate charging by receiving a charging current from an external peripheral (such a charger, a computer or a charging station, etc.) via the socket connector 571, and charge the battery using the received charging current. When it is determined that the battery is fully charged, the power management unit 575 may inform the processor 512. The processor 512 may then cause the switch unit 573 of the external port unit 570 to block or ground a circuit correlating to battery charging.

The other input/control units 580 may include an up/down button for volume control, a push button, a locker button, a locker switch, a thumb-wheel, a dial, a stick, and/or a pointer device (such as a stylus). Any desired functionality may be included in the user apparatus 500 as required.

The touchscreen unit 590 provides an input/output interface for the user. The touchscreen unit 590 utilizes touch-detecting technology and is capable of transmitting a user's touch input to the host unit 510. The touchscreen unit 590 preferably includes a display for displaying an image. The touchscreen unit may therefore be capable of displaying visual information such as text, graphics, videos, etc. to the user. The display may be one of an Electro Wetting Display (“EWD”), an E-Paper, a Plasma Display Panel (“PDP”), a Liquid Crystal Display (“LCD”), an Organic Light Emitting Diode (“OLED”), and an Active Matrix Organic Light Emitting Diodes (“AMOLED”). The touchscreen unit may further include a device for receiving touch inputs from a user. The device may be (for example) a digitizer for a stylus pen, a capacitive overlay touch panel, a resistance overlay touch panel, a surface acoustic wave touch panel, or an infrared beam touch panel.

The external memory unit 520 may include high speed random access memory, one or more magnetic disc storage device and/or a non-volatile memory, and/or one or more optical storage device and/or a flash memory (for example, “NAND” and “NOR” type memory). The external memory unit 520 may in some situations store programs (expressible as a set of instructions, instructions sets, or a module) and software program instructions executable by the processor. Executable software may include an Operating System (“OS”) program, a communication program, a graphic program, a user interface program, a CODEC program, and one or more applications.

The OS program may denote WINDOWS, LINUX, Darwin, RTXC, UNIX, OS X, or a built-in OS such as VxWorks, and may include various software elements for facilitating and controlling general system operation. This may include memory management and control, storage hardware control and management, power control and management, etc. The OS program may also facilitate efficient communication between various hardware devices and a various software elements.

The communication program may enable communication with a computer, a server, and/or a counterpart electronic device via the wireless communication unit 550 or the external port unit 570.

The graphic program may facilitate the rendering and display of graphic elements on the touchscreen unit 590, such as text, digital images, videos, animations, webpages, graphical icons, user interfaces, etc.

The user interface program may facilitate user interaction with the user apparatus 500. The user interface program may include instructions controlling changes in the state of the user interface, defining how when changes occur, and controlling execution of the changes when they do occur.

The CODEC program may facilitate encoding and decoding of a video file.

The camera program may include a camera-related program enabling camera-related processes and functions, such as capturing images, video, viewing captured images and video, and editing captured images and video.

The application may include programs for facilitating Internet browsing, e-mail, instant messaging, word processing, keyboard emulation, contact lists or address books, touch lists, a widgets, a Digital Right Management (DRM), voice recognition, voice duplication, a position determining function, a location based service, etc.

The user apparatus 500 may include additional programs besides the above-described programs. The various functions of the user apparatus 500 may be executed by a variety of programming and processing paradigms, such as parallel processing, stream processing, or specialized hardware (such as an Application Specific Integrated Circuit or “ASIC”), etc., or some combination thereof.

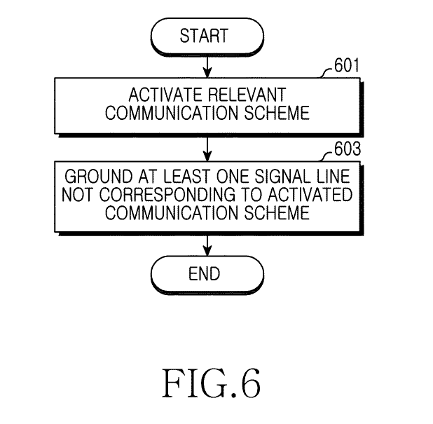

FIG. 6 is a flowchart illustrating a method of using a USB signal line as an electric ground according to one embodiment of the present invention. The processor 512 activates a relevant communication scheme in step 601. The communication scheme may be, for example, the USB 3.0 communication scheme or the USB 2.0 communication scheme. The processor 512 may then ground at least one signal line not corresponding to the activated communication scheme in step 603.

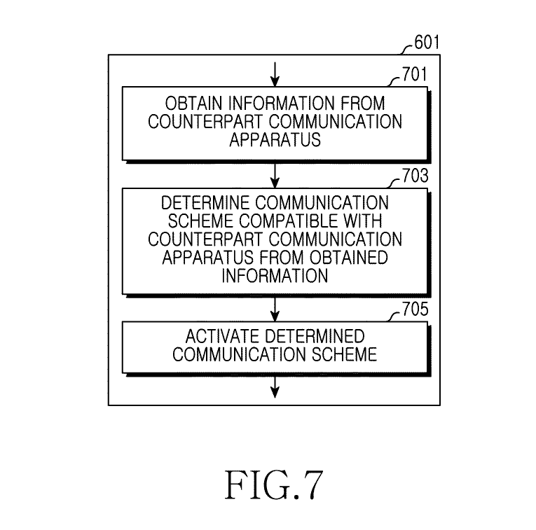

FIG. 7 is a flowchart illustrating a method of determining which USB signal line should be activated according to one embodiment of the present invention (corresponding to step 603 of FIG. 6). The processor 512 may receive information from a counterpart communication apparatus in step 701. The information may include a device name, a Media Access Control (MAC) address, a manufacturer, a manufacture date, a communication scheme, etc. In step 703, the processor 512 may determine a communication scheme compatible with the counterpart communication apparatus from the received information. For example, the received information may indicate that a USB 3.0 communication scheme is appropriate. In step 705, the processor 512 may activate the appropriate communication scheme. For example, the host unit 510 (and processor 512) may cause the switch unit 573 to communicatively couple a signal line from a coupled USB 3.0 cable correlating to a USB 3.0 communication scheme, while simultaneously grounding a signal line from the coupled USB 3.0 cable correlating to a USB 2.0 communication scheme.

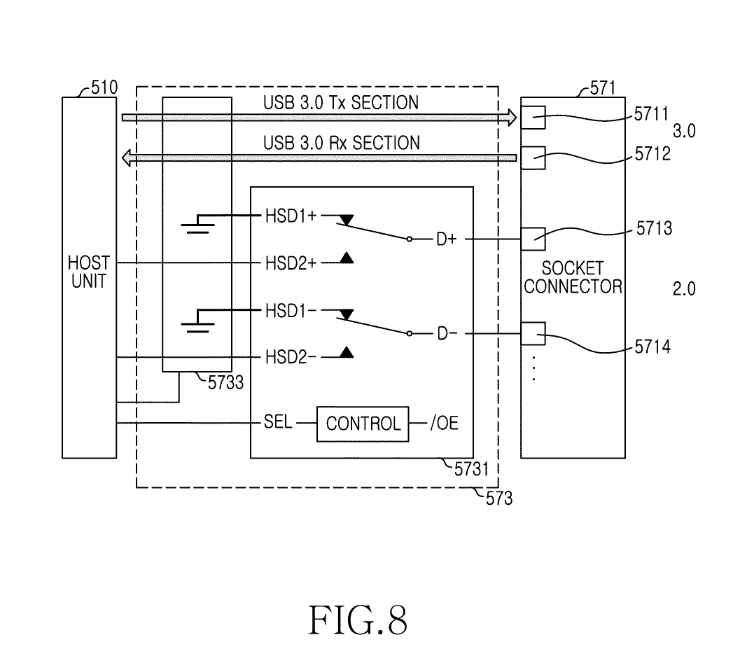

FIGS. 8 to 11 are block diagrams illustrating various communication configurations between a host unit and a socket connector according to one embodiment of the present invention.

When a USB 3.0 communication cable plug connector 201 is coupled to the socket connector 571, the terminals 1334 on the socket connector 571 contact the terminals of the plug connector 201. As described above, the terminals may include a Tx terminal 5711 and an Rx terminal 5712 for the USB 3.0 communication, a D+ terminal 5713 and a D-terminal 5714 for the USB 2.0 communication, and may include other terminals, such as a ground terminal, a power transmission terminal, an Identification (ID) terminal, etc.

The ground terminal may be connected with the ground of the mainboard 130 via a line, the power transmission terminal may be connected with the power management unit 575 via a line, and the ID terminal may be connected with the host unit 510 via a line. The Tx terminal 5711, the Rx terminal 5712, the D+ terminal 5713, and the D-terminal 5714 may be connected to the host unit 510 via lines as well, respectively. These lines may be realized in the form of a circuitry pattern on the mainboard 130.

The external port unit 570 may include the switch unit 573 for controlling lines between the host unit 510 and the socket connector 571. The switch unit 573 may “cut off” or otherwise electrically disconnect a relevant line or connect a relevant line to the ground, disabling that particular line. The switch unit 573 may include a first switch device 5731 and a second switch device 5733. The first switch device 5731 includes a D+ port, a D− port, an HSD1+ port, an HSD2+ port, an HSD1− port, an HSD2− port, an SEL port, an /OE port, etc. The D+ port and the D− port may relate to a USB data bus, the HSD1− port and the HSD1+ port may relate to a “Universal Asynchronous Receiver Transmitter” (“UART”)/USB communication, and the HSD2− port and the HSD2+ port may relate to USB communication. The SEL port may relate to switch selection and the /OE port may relate to enabling the switch. The switch unit 573 may be realized in the form of a switch device mounted on the mainboard 130.

The D+ port of the first switch device 5731 may be connected with the D+ terminal 5713 of the socket connector 571, and the D− port of the first switch device 5731 may be connected with the D− port 5714 of the socket connector 571. The SEL port of the first switch device 5731 may be connected with the host unit 510. The HSD1+ port, the HSD2+ port, the HSD1− port, the HSD2− port of the first switch device 5731 may be connected to the host unit 510, or disconnected from the host unit 510, grounded by control of the second switch device 5733.

Referring now to FIG. 8, when the host unit 510 determines that a USB 3.0 communication scheme is appropriate for a peripheral communicatively coupled via a USB 3.0 communication cable described herein, the host unit 510 may activate USB 3.0 communication by instructing the second switch device 5733 to prepare a USB 3.0 Tx section via a signal line coupling the Tx terminal 5711 with the host unit 510. The second switch device 5733 may similarly prepare a USB 3.0 Rx section via a signal line connecting the Rx terminal 5712 with the host unit 510. Meanwhile, in the case where a “LOW” signal is received at the host unit 510, the first switch device 5731 may select the HSD1+ port and the HSD1− port via the SEL port and the /OE port, and thereby connect the D+ port with the HSD1+ port, and connect the D− port with the HSD1− port. In this situation, the second switch device 5733 does not connect the HSD1+ port and the HSD1− port of the first switch device 5731 with the host unit 510. The depicted result shows that in this configuration, the signal lines from the HSD1+ and the HSD1− corresponding to the USB 2.0 communication scheme are grounded to the host unit 510.

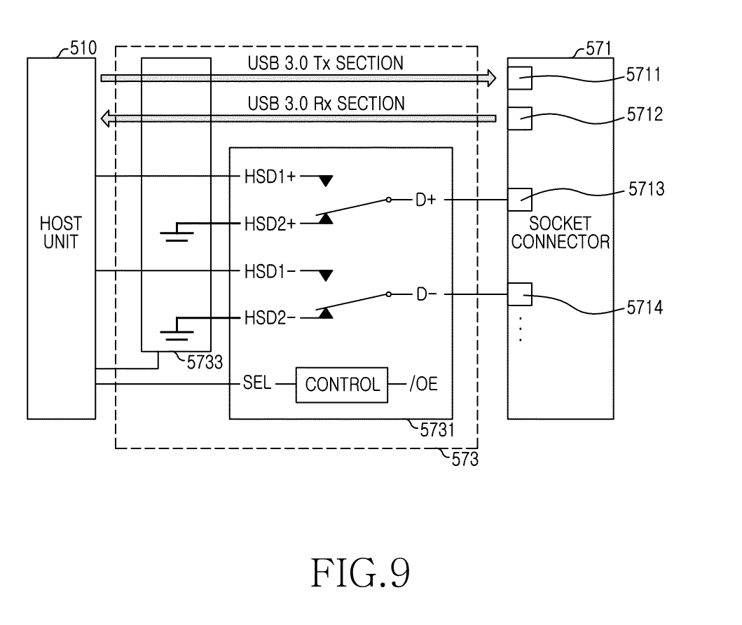

Referring to FIG. 9, when the host unit 510 determines that a USB 3.0 communication scheme is appropriate for a peripheral communicatively coupled via a USB 3.0 communication cable described herein, the host unit 510 may activate USB 3.0 communication by instructing the second switch device 5733 to prepare a USB 3.0 Tx section via a signal line connecting the Tx terminal 5711 with the host unit 510. The second switch device 5733 may prepare a USB 3.0 Rx section via a signal line connecting the Rx terminal 5712 with the host unit 510. Meanwhile, in the case where a “HIGH” signal is received at the host unit 510, the first switch device 5731 may select the HSD2+ port and the HSD2− port via the SEL port and the /OE port, connect the D+ port with the HSD2+ port, and connect the D− port with the HSD2− port. In this situation, the second switch device 5733 does not connect the HSD2+ port and the HSD2− port of the first switch device 5731 with the host unit 510. The depicted result shows that in this configuration, the signal lines from the HSD2+ and the HSD2− corresponding to the USB 2.0 communication scheme are grounded to the host unit 510.

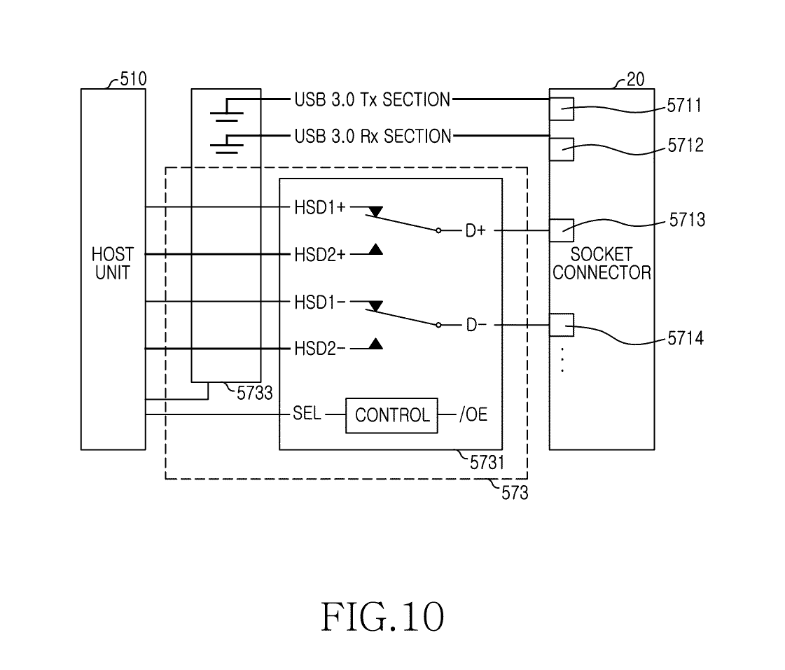

Referring to FIG. 10, when the host unit 510 determines that a USB 2.0 communication scheme is appropriate for a peripheral communicatively coupled via the USB 3.0 communication cable described herein, the host unit 510 may activate USB 2.0 communication. In the case where a “LOW” signal is received at the host unit 510, the first switch device 5731 may select the HSD1+ port and the HSD1− port via the SEL port and the /OE port, connect the D+ port with the HSD1+ port, and connect the D− port with the HSD1− port. The host unit 510 does not activate USB 3.0 communication. The second switch device 5732 does not connect the Tx terminal 5711 and the Rx terminal 5712 of the socket connector 571 to the host unit 510, and instead grounds the signal lines from the Tx terminal 5711 and the Rx terminal 5712 of the socket connector 571, these being the signal lines that correspond to the USB 3.0 communication scheme.

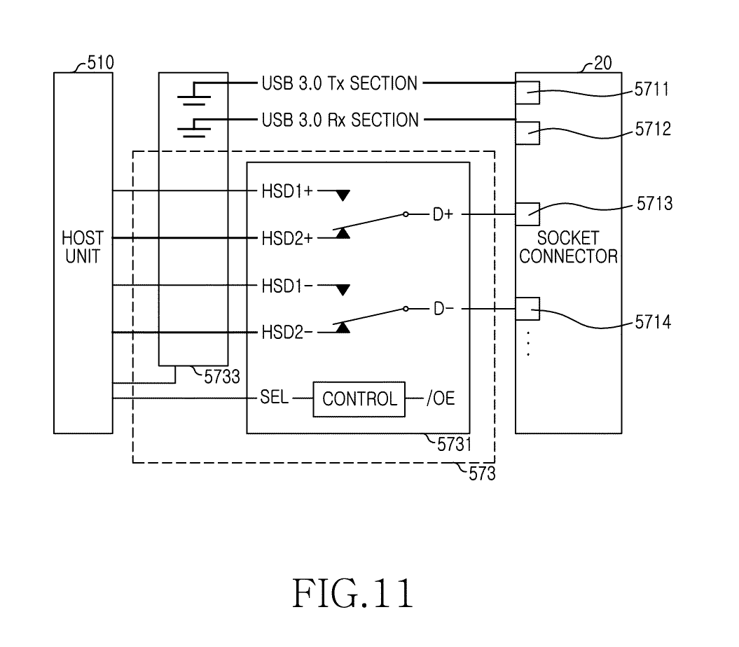

Referring to FIG. 11, when the host unit 510 determines that a USB 2.0 communication scheme is appropriate for a peripheral communicatively coupled via the USB 3.0 communication cable described herein, the host unit 510 may activate USB 2.0 communication. In the case where a “HIGH” signal is received at the host unit 510, the first switch device 5731 may select the HSD2+ port and the HSD2− port via the SEL port and the /OE port, connect the D+ port with the HSD2+ port, and connect the D− port with the HSD2− port. The host unit 510 does not activate USB 3.0 communication. The second switch device 5732 does not connect the Tx terminal 5711 and the Rx terminal 5712 of the socket connector 571 to the host unit 510, and instead grounds signal lines from the Tx terminal 5711 and the Rx terminal 5712 of the socket connector 571, these being the signal lines that correspond to the USB 3.0 communication scheme.

The methods according to the embodiments described in claims and/or the specifications of the present invention may be implemented in the form of hardware, software, or a combination of hardware and software.

In case of implementation as software, a computer readable storage medium that stores one or more programs (software program) may be provided. One or more programs stored in the computer readable storage medium are configured for execution by one or more processors inside an electronic device. One or more programs include instructions for allowing the electronic device to execute methods according to the embodiments described in claims and/or specification of the present invention.

The program may be stored in a random access memory, a non-volatile memory including a flash memory, Read Only Memory (ROM), Electrically Erasable Programmable Read Only Memory (EEPROM), a magnetic disc storage device, Compact Disc-ROM (CD-ROM), Digital Versatile Discs (DVDs) or other types of optical storage device, and a magnetic cassette. Alternatively, the program may be stored in a memory configured by a combination of all or a portion of these. Also, a plurality of memory devices may be provided.

Although the invention has been shown and described with reference to certain example embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

In a USB 3.0 communication cable, according to the embodiments of the present invention, a USB 2.0 communication signal line is included to enable backwards compatibility, and is surrounded by the rest of the lines. A USB 3.0 communication signal line is spaced apart from a power transmission line, thus reducing crosstalk, noise and/or interference introduced by the power transmission line.

Since an electronic device according to the embodiments of the present invention applies the USB 3.0 communication, it may perform high speed data transmission in accordance with USB 3.0 communication standards.

A cable and an electronic device are connected by way of fitting a plug connector coupled to the end of the USB 3.0 cable to the socket connector of the electronic device. When USB 3.0 communication is activated, the electronic device grounds at least one line corresponding to USB 2.0 communication. The use of a USB 2.0 communication signal line of the USB 3.0 communication cable as an additional ground body improves signal integrity and deters crosstalk and electrical noise.

What is claimed is:

1. A method for reducing crosstalk in a signal transmitted to an electronic device through a cable having a plurality of signal lines, the method comprising:
activating a relevant communication scheme; and
grounding at least one signal line that does not correspond to the activated relevant communication scheme.

2. The method of claim 1, further comprising:
communicatively coupling at least one signal line corresponding to the activated communication line.

3. The method of claim 1, wherein the activated relevant communication scheme is a communication scheme compatible with a counterpart communication apparatus.

4. The method of claim 1, wherein the at least one signal line that does not correspond to the activated relevant communication scheme is connected with a terminal for connecting a counterpart peripheral.

5. The method of claim 1, wherein the at least one signal line that does not correspond to the activated relevant communication scheme corresponds to a communication scheme of an older revision or a newer revision relative to the activated relevant communication scheme.

6. The method of claim 5, wherein the activated relevant communication scheme is a Universal Serial Bus (USB) 3.0 communication scheme or a USB 2.0 communication scheme.

7. An electronic device comprising:
at least one processor;
a memory;
a switch device electrically connected with the processor; and
program instructions stored in the memory and configured for execution by the at least one processor, wherein the program instructions are executable by the processor to:
activate a relevant communication scheme; and
cause the switch device to ground at least one signal line not corresponding to the activated relevant communication scheme.

8. The electronic device of claim 7, wherein the program instructions further comprise controlling the switch device to electrically couple at least one signal line corresponding to the activated relevant communication scheme with the processor.

9. The electronic device of claim 7, wherein the activated relevant communication scheme is a communication scheme compatible with a counterpart communication apparatus.

10. The electronic device of claim 7, wherein the program instructions further comprise coupling at least one signal line not corresponding to the activated relevant communication scheme to a terminal for connecting a counterpart peripheral.

11. The electronic device of claim 7, wherein the at least one signal line not corresponding to the activated relevant communication scheme corresponds to a communication scheme of a newer revision or an older review relative to the activated relevant communication scheme.

12. The electronic device of claim 11, wherein the activated relevant communication scheme is a USB 3.0 communication scheme or a USB 2.0 communication scheme.

13. An electronic device comprising:
a mainboard;
a socket connector mounted on the mainboard for connecting a peripheral; and
a switch device mounted on the mainboard for controlling a plurality of signal lines electrically coupled with the socket connector,
wherein the switch device grounds at least one signal line not corresponding to an activated communication scheme among the signal lines.

14. The electronic device of claim 13, wherein the switch device electrically couples at least one signal line from the plurality of signal lines with the socket connector, the coupled at least one signal line corresponding to the activated communication scheme.

15. The electronic device of claim 13, wherein the activated communication scheme is a communication scheme compatible with a counterpart communication apparatus.

16. The electronic device of claim 13, wherein the at least one signal line not corresponding to the activated communication scheme corresponds to a communication scheme of an older revision or a newer revision relative to the activated communication scheme.

17. The electronic device of claim 16, wherein the activated communication scheme is a USB 3.0 communication scheme or a USB 2.0 communication scheme.

18. A cable comprising:
a sheath; and
a plurality of lines disposed inside the sheath,
wherein at least one line corresponding to a first communication scheme is disposed within the sheath nonadjacently to at least one other line corresponding to a second communication scheme.

19. The cable of claim 18, wherein the at least one line corresponding to the first communication scheme is disposed near a center of the cable.

20. The cable of claim 18, wherein the first communication scheme is an older revision or a newer revision relative to the second communication scheme.
